(19) United States
(12) Patent Application Publication
(10) Pub. No.: US 2001/0005421 A1
(43) Pub. Date: Jun. 28, 2001

(54) Loudspeakers

(76) Inventor: Neil Harris, Cambridge (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/741,736

(22) Filed: Dec. 21, 2000

Related U.S. Application Data
(60) Provisional application No. 60/171,295, filed on Dec. 21, 1999.

(30) Foreign Application Priority Data
Dec. 21, 1999 (GB) 9930275.4

(51) Int. Cl. H04R 1/02; H04R 9/06

(52) U.S. Cl. 381/332

(57) ABSTRACT

A loudspeaker comprises an acoustic radiator (10) (e.g., a panel) capable of supporting bending waves, an exciter mounted on the acoustic radiator (10,28) to excite bending waves in the acoustic radiator (10,28) to produce an acoustic output, and a filter (12,30) located adjacent to the acoustic radiator (10,28) for directing the acoustic output from the acoustic radiator (10,28). The filter (12,30) is adapted to have a pattern (11) of varying acoustic absorbency, the pattern (11) being selected to produce a desired directivity of the acoustic output. The filter (12,30) may be in the form of an acoustic mask comprising a pattern (11) of at least one acoustic aperture (14,16).

This application claims the benefit of provisional application No. 60/171,295, filed Dec. 21, 1999.

### TECHNICAL FIELD

The invention relates to loudspeakers. More particularly, but not exclusively, the invention relates to resonant panel-form loudspeakers generally of the kind disclosed in International patent application W097/09842 of New Transducers Ltd.

### BACKGROUND ART

Recently, a new form of loudspeaker has been developed by New Transducers Ltd., as described in several patent applications, for example WO97/09842, and counterpart U.S. application No. 08/707,012, filed Sep. 3, 1996. Such loudspeakers use resonant bending wave modes excited by a transducer to produce output sound and are referred to as “distributed mode” loudspeakers.

Such a resonant panel-form loudspeaker typically comprises a member having capability to sustain and propagate input vibrational energy by bending waves in at least one operative area extending transversely of thickness to have resonant mode vibration components distributed over that area. There are preferential locations or sites within that area for mounting at least one transducer for vibrating the member to cause it to resonate, forming an acoustic radiator. Acoustic radiation from such a loudspeaker is characteristically substantially omni-directional.

### SUMMARY OF THE INVENTION

It is an object of the invention to assist in controlling the directivity of the acoustic radiation from a loudspeaker, particularly a resonant panel loudspeaker.

From one aspect the invention is loudspeaker comprising an acoustic radiator capable of supporting bending waves, a transducer mounted on the acoustic radiator to excite bending waves in the acoustic radiator to produce an acoustic output, and a filter located adjacent to the acoustic radiator for directing the acoustic output from the acoustic radiator. The filter is adapted to have a pattern of varying acoustic absorbency, the pattern being selected to produce a desired directivity of the acoustic output.

The filter may be in the form of an acoustic mask comprising a pattern of at least one acoustic aperture. Thus, the desired directivity may be achieved by purely mechano-acoustic means, without associated electronic components or signal processing.

The or each acoustic aperture may be of arbitrary shape. In particular, any of the acoustic apertures may be in the form of a hole or a slot. (The width of a hole is similar to its height, whereas the width of a slot is large compared to its height.) In particular, if the value 1 denotes unrestricted transmission, ideally the pattern of acoustic apertures may be a binary function wherein the value 1 represents a hole or a slot and the value 0 denotes no transmission. Clearly, it is impossible to realise an acoustic aperture which is outside the range [0,1] passively.

Alternatively or additionally, variable damping may be provided as a way of controlling directivity from a resonant panel loudspeaker. Accordingly, from a second aspect the filter may be in the form of a plate of contoured acoustic foam giving position dependent absorption. Any acoustically absorbing material, such as those used in the noise reduction industry, would be a suitable alternative to acoustic foam. Examples include pads or blocks of acoustic fibre, e.g., polyester or bonded acetate, and polyurethane and polyester foams of a range of densities.

The acoustic mask is preferably of a material which does not propagate the acoustic output from the radiator, i.e. the mask is preferably acoustically opaque and nonresonant. The acoustic mask may be co-extensive with the resonant panel. The acoustic mask is preferably not directly connected to the panel, to prevent direct transmission of acoustic energy from the panel to the mask. The distance between the mask and the panel is preferably as small as possible and is preferably significantly less than the shortest acoustic wavelength in the operating frequency range, i.e., less than about 50%, preferably less than about 25%, and ideally less than about 10% of that wavelength.

It is preferred, though not essential, to use as the loudspeaker a resonant bending wave mode loudspeaker having an acoustic radiator and a transducer fixed to the acoustic radiator for exciting resonant bending wave modes. Such a “distributed mode loudspeaker” is described in WO97/09842 and counterpart U.S. application No. 08/707,012, filed Sep. 3, 1996 (the latter being incorporated by reference herein in its entirety). The acoustic radiator may be in the form of a panel. The panel may be flat and may be lightweight. The material of the acoustic radiator may be anisotropic or isotropic.

The mechanical vibrations (V) of the radiator can be represented by the spatial Fourier transform of the excitation (strictly speaking, the decomposition is into a sum of plate functions, rather than sinusoids),

i.e. V=ℑ(sources).

The far-field directivity P is the spatial Fourier transform of the plate velocity,

i.e., P=ℑ(V)=ℑ(ℑ(sources)).

By placing a filter in front of the resonant panel loudspeaker, the far-field directivity is a function of the plate velocity and the filter, and is thus dependent on the pattern, i.e. position and shape of acoustic apertures in the filter,

i.e., Filter=ℑ⁻¹(P₁)/V=ℑ⁻¹(P₁)/ℑ(sources).

Thus the pattern of acoustic apertures is a function of the desired far-field directivity and may be determined so as potentially to produce any desired directivity P₁.

In practice an arbitrary and complex transmission index for the filter may not be easy to produce.

Alternatively, the pattern of acoustic aperture(s) of the filter may be calculated by determining the precise pattern which minimises the error between the desired directivity and the directivity as calculated with the filter in place. For example, initially the directivity with a relatively simple filter comprising a set of holes or slots may be calculated and by using standard techniques to minimise

Err=∫(ℑ(V.Filter)−P₁)²ds

the precise form of perforation may be selected.

This method for calculating the position and/or shape of the hole(s) and slot(s) is similar to focal-plane processing which is used in the field of optics. Focal-plane processing uses the fact that an optical lens produces at its focus, a spatial Fourier transform of the source. The transformed image is selectively obscured by a pattern of slots, holes, rings etc., effecting a spatial filter. The image is formed using a second lens to invert the Fourier transform. It is possible that the source is virtual, whereby an illuminated shadow mask (or hologram) is focused to produce a pre-calculated image. Thus a combination of lenses and shadow masks are used to process images. These systems work best in monochromatic light.

One advantage that optics has over acoustics is the relatively narrow bandwidth that is required. White light covers less than one octave of wavelengths, whereas the acoustic equivalent can cover up to three decades.

However, some benefit may be gained over a restricted frequency range. Investigation of the concept using a beam showed that in the speech band (300 Hz-3 kHz), improvements in directivity were achievable.

Furthermore, the method may be used in conjunction with standard optimisation techniques to give desired levels of optimality over specified frequency ranges.

For example, the opacity of the mask may not be absolute, i.e. the mask strength may be between 0 and 1 (or even complex). Optimisation may then be applied and may produce a different solution to the binary case.

### BRIEF DESCRIPTION OF THE DRAWING

Examples that embody the best mode for carrying out the invention are described in detail below and are diagrammatically illustrated in the accompanying drawing, in which:

FIG. 1 is a perspective view of a first embodiment of loudspeaker according to the invention;

FIG. 1A is a schematic cross-sectional view of a typical loudspeaker according to the invention;

FIG. 2 is a schematic edge view of a second embodiment of loudspeaker according to the invention;

FIG. 3 is a plot of the directivity of the unfiltered resonant panel loudspeaker shown in FIG. 2; and

FIG. 4 is a plot of the directivity of the resonant panel loudspeaker of FIG. 2 filtered according to the invention.

### DETAILED DESCRIPTION

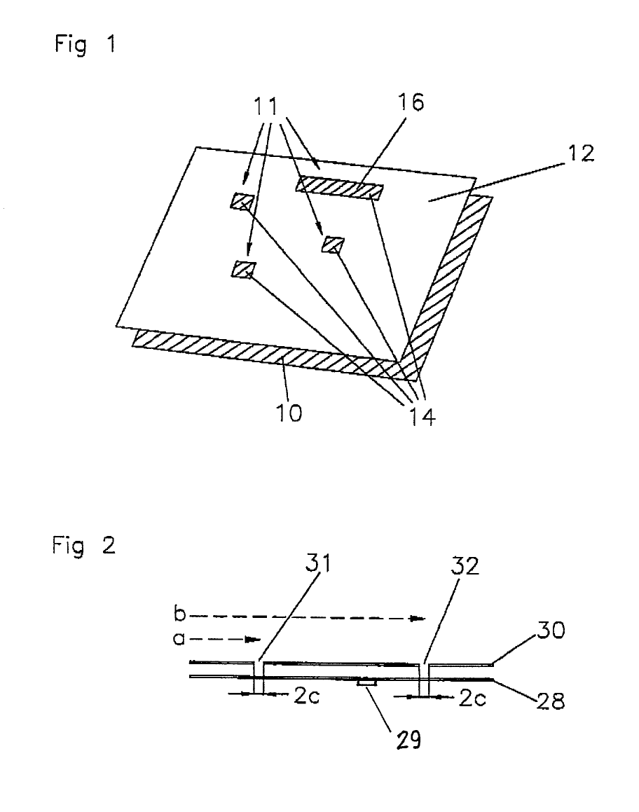

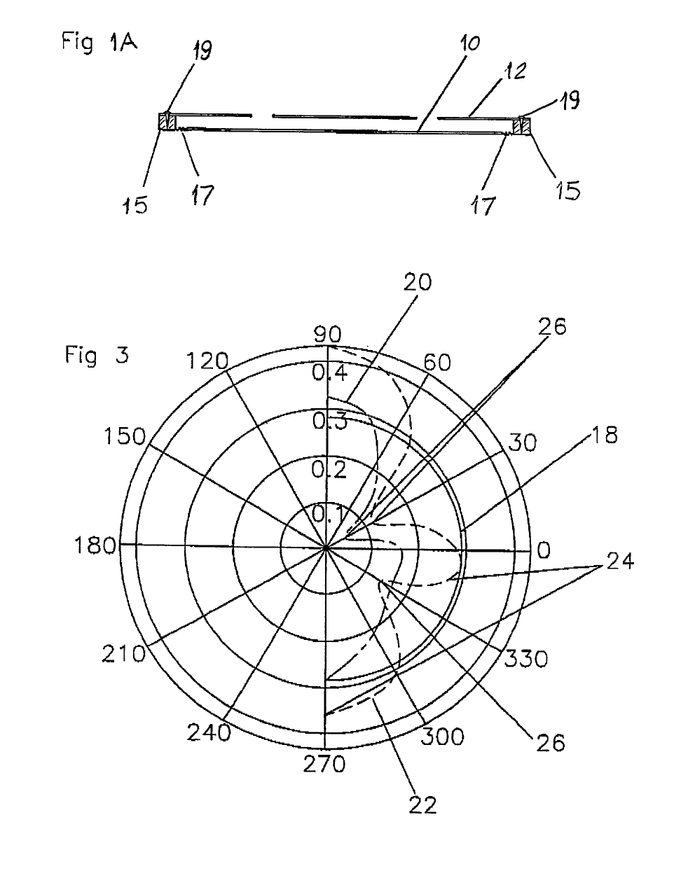

FIG. 1 shows an acoustic radiator (10) in the form of a resonant panel and substantially co-extensive filter (12) located in front of and adjacent to the radiator (10) for directing acoustic output from the radiator (10), the filter (12) being in the form of an acoustic mask comprising four acoustic apertures. The pattern (11) of acoustic apertures is determined so as to produce the desired directivity of acoustic output. The pattern of acoustic apertures consists of three holes (14) and one slot (16).

The acoustic radiator (10) is preferably of the kind described in International application WO97/09842 and U.S. 08/707,012. Thus, the properties of the acoustic radiator (10) may be chosen to distribute the resonant bending wave modes, particularly the lower frequency resonant bending wave modes, substantially evenly in frequency. The lower frequency resonant bending wave modes are preferably the ten to twenty lowest frequency resonant bending wave modes of the acoustic radiator. The resonant bending wave modes associated with each conceptual axis of the acoustic radiator may be arranged to be interleaved in frequency. There may be two conceptual axes and the axes may be symmetry axes.

The transducer location may be chosen to couple substantially evenly to the resonant bending wave modes. In particular, the transducer location may be chosen to couple substantially evenly to lower frequency resonant bending wave modes. The transducer may be at a location where the number of vibrationally active resonance antinodes is relatively high and conversely the number of resonance nodes is relatively low.

The filter (12) is not directly connected to the acoustic radiator (10). FIG. 1A shows one way of mounting the filter (12) adjacent to the acoustic radiator (10). The acoustic radiator (10) is surrounded by a solid frame (15), and is supported on the frame (15) by a compliant interface or suspension (17) which extends around the periphery of the acoustic radiator (10). The filter (12) is attached to the frame (15) by solid fixings (19), e.g. screws or nails.

FIG. 2 schematically shows a loudspeaker comprising an acoustic radiator (28) in the form of a resonant panel with a transducer (29), and a substantially co-extensive filter (30) located in front of and adjacent to the radiator (28) for directing acoustic output from the radiator (28). The filter (30) is in the form of an acoustic mask comprising two acoustic apertures (31,32). The position and width of acoustic apertures (31,32) is determined so as to produce the desired directivity of acoustic output. The acoustic mask (A) is calculated from a simple function

A(a,b,c,ξ)=(|ξ−a|<c)+(|ξ−b|<c), |b−a|>2.c

which defines two holes both of radius c and centred at positions a and b respectively. The values of a, b and c are then calculated to give the desired directivity P₁ by minimising the error between the desired directivity and the calculated directivity using the least mean squared relationship. The calculated values are a=0.185092, b=0.7145, c=0.099741.

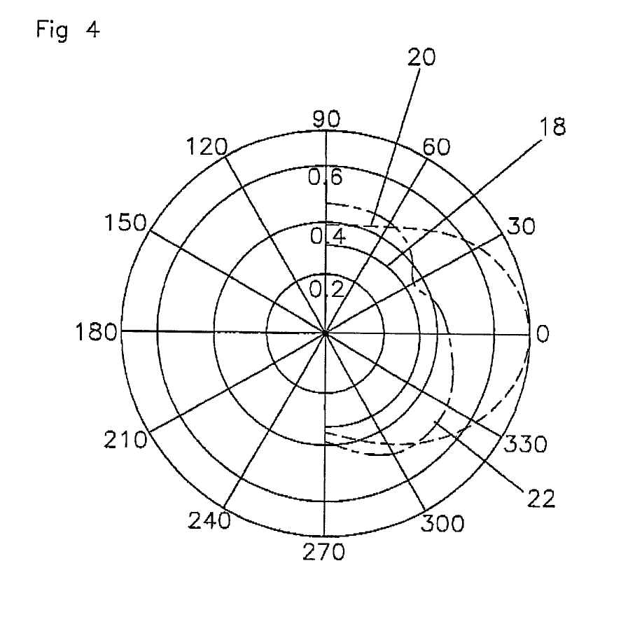

FIG. 3 shows the normal, i.e. unfiltered directivity of the resonant panel of FIG. 2 at three frequencies, namely 300 Hz (18), 1 kHz (20) and 3 kHz (22). At 300 Hz, the acoustic output is uniformly distributed. At the higher frequencies there are peaks (24) in the acoustic output at 90°, 0° and 270° and troughs (26) at 30° and 330°.

When an acoustic mask as shown in FIG. 2 is placed in front of the panel, the directivity, in particular the uniformity of the acoustic output of the panel is improved as illustrated in FIG. 4. The directivity at 1 kHz (20) and 3 kHz (22) is now more uniform with the troughs at 30° and 330° in the unfiltered output generally eradicated. The directivity of acoustic output at 300 Hz is substantially unchanged and thus remains uniform.

1. A loudspeaker comprising an acoustic radiator capable of supporting bending waves, a transducer mounted on the acoustic radiator to excite bending waves in the acoustic radiator to produce an acoustic output, and a filter located adjacent to the acoustic radiator for directing the acoustic output from the acoustic radiator, said filter having a pattern of varying acoustic absorbency, the pattern being selected to produce a desired directivity of the acoustic output.

2. A loudspeaker according to claim 1, wherein the filter is in the form of an acoustic mask comprising a pattern of at least one acoustic aperture.

3. A loudspeaker according to claim 2, wherein the acoustic mask is made of a material which is acoustically opaque.

4. A loudspeaker according to claim 3, wherein the pattern of acoustic apertures is a binary function such that the value 1 represents an aperture and the value 0 denotes no transmission.

5. A loudspeaker according to claim 4, wherein the pattern of acoustic apertures is calculated to produce any desired far-field directivity by using
Filter=ℑ⁻¹(P₁)/ℑ(sources).

6. A loudspeaker according to claim 4, wherein the pattern of acoustic apertures is calculated by determining the pattern which minimises the error between the desired directivity and the directivity as calculated with the filter in place.

7. A loudspeaker according to claim 2, wherein the pattern of acoustic apertures is calculated by determining the pattern which minimises the error between the desired directivity and the directivity as calculated with the filter in place.

8. A loudspeaker according to claim 2, wherein at least one of the acoustic apertures is in the form of a hole.

9. A loudspeaker according to claim 8, wherein at least one of the acoustic apertures is in the form of a slot.

10. A loudspeaker according to claim 2, wherein at least one of the acoustic apertures is in the form of a slot.

11. A loudspeaker according to claim 1, wherein the filter is in the form of a plate of contoured acoustic foam giving position dependent absorption.

12. A loudspeaker according to claim 11, wherein the filter is co-extensive with the acoustic radiator.

13. A loudspeaker according to claim 1, wherein the filter is co-extensive with the acoustic radiator.

14. A loudspeaker according to claim 1, wherein the filter is not directly connected to the acoustic radiator.

15. A loudspeaker according to claim 1, wherein the distance between the filter and the acoustic radiator is less than about 50% of the shortest acoustic wavelength in the operating frequency range.

16. A loudspeaker according to claim 15, wherein the distance between the filter and the acoustic radiator is less than about 25% of the shortest acoustic wavelength in the operating frequency range.

17. A loudspeaker according to claim 16, wherein the distance between the filter and the acoustic radiator is less than about 10% of the shortest acoustic wavelength in the operating frequency range.

18. A loudspeaker according to claim 1, wherein the acoustic radiator is capable of supporting resonant bending wave modes and the transducer excites the resonant bending wave modes.

19. A loudspeaker according to claim 18, wherein the acoustic radiator is in the form of a panel.

20. A loudspeaker comprising an acoustic radiator in the form of a panel capable of supporting bending waves, a transducer mounted on the panel to excite bending waves in the panel to produce an acoustic output, and a filter located adjacent but not directly connected to the panel for directing the acoustic output from the panel, said filter having a pattern of varying acoustic absorbency, the pattern being selected to produce a desired directivity of the acoustic output.

21. A loudspeaker according to claim 20, wherein the distance between the filter and the panel is less than about 50% of the shortest acoustic wavelength in the operating frequency range.

22. A loudspeaker according to claim 21, wherein the distance between the filter and the panel is less than about 25% of the shortest acoustic wavelength in the operating frequency range.

23. A loudspeaker according to claim 22, wherein the distance between the filter and the panel is less than about 10% of the shortest acoustic wavelength in the operating frequency range.

24. A loudspeaker according to claim 20, wherein the filter is in the form of an acoustic mask comprising a pattern of at least one acoustic aperture.

25. A loudspeaker according to claim 24, wherein the acoustic mask is made of a material which is acoustically opaque.

26. A loudspeaker according to claim 25, wherein the pattern of acoustic apertures is a binary function such that the value 1 represents an aperture and the value 0 denotes no transmission.

27. A loudspeaker according to claim 26, wherein the pattern of acoustic apertures is calculated to produce any desired far-field directivity by using
Filter=ℑ⁻¹(P₁)/ℑ(sources).

28. A loudspeaker according to claim 25, wherein the pattern of acoustic apertures is calculated by determining the pattern which minimises the error between the desired directivity and the directivity as calculated with the filter in place.

29. A loudspeaker according to claim 24, wherein the pattern of acoustic apertures is calculated by determining the pattern which minimises the error between the desired directivity and the directivity as calculated with the filter in place.

30. A loudspeaker according to claim 24, wherein at least one of the acoustic apertures is in the form of a hole.

31. A loudspeaker according to claim 30, wherein at least one of the acoustic apertures is in the form of a slot.

32. A loudspeaker according to claim 24, wherein at least one of the acoustic apertures is in the form of a slot.

33. A loudspeaker according to claim 20, wherein the filter is in the form of a plate of contoured acoustic foam giving position dependent absorption.

34. A loudspeaker according to claim 33, wherein the filter is co-extensive with the panel.

35. A loudspeaker according to claim 20, wherein the filter is co-extensive with the panel.

36. A loudspeaker according to claim 1, wherein the panel is capable of supporting resonant bending wave modes and the transducer excites the resonant bending wave modes.
